(19) United States
(12) Patent Application Publication
(10) Pub. No.: US 2015/0202933 A1
(43) Pub. Date: Jul. 23, 2015

(54) EXTERNAL VALVE POSITIONING FOR DROP CENTER WHEELS

(71) Applicants: Badrinarayanan Ramachandra Rao, Chennai (IN); Sundararajan Thiyagarajan, Chennai (IN); Rajaram Balaseshan, Chennai (IN)

(72) Inventors: Badrinarayanan Ramachandra Rao, Chennai (IN); Sundararajan Thiyagarajan, Chennai (IN); Rajaram Balaseshan, Chennai (IN)

(21) Appl. No.: 14/129,256

(22) PCT Filed: Aug. 23, 2013
(86) PCT No.: PCT/IN2013/000512

§ 371 Date: Dec. 27, 2013

(30) Foreign Application Priority Data
Aug. 27, 2012 (IN) 3541/CHE/2012

(51) Int. Cl. B60C 29/02

(52) U.S. Cl. CPC B60C 29/02

(57) ABSTRACT

In view of the foregoing, an embodiment herein provides a commercial vehicle wheel comprises of a rim 101, and a disc 102, wherein the rim 101 includes an outer flange 103, an inner flange 104, an outer bead seat 105, an inner bead seat 106, a connecting region 107 for connecting the rim 101 and disc 102, a circumferential mounting groove 108 connected between the connecting region 107 and inner bead seat 106, wherein a valve hole 109 is provided in the outer bead seat 105 for positioning a valve 110, wherein the valve 110 stem is externally projecting outside the disc 102, thereby results in pave the way for achieving larger clearance between the valve and drum/calliper. The outer bead seat is straight across the radius of rim except the valve hole 109 region, and provided without having hump, ledger and/or intermediate ring in the rim 101.

### FIELD OF INVENTION

The embodiments herein generally relate to commercial vehicle wheel, more particularly, to a wheel includes a rim, a disc, and a valve, wherein the valve positioned in such a way to have larger clearance between valve and drum/caliper.

### BACKGROUND AND PRIOR ART

A wheel is made up of a rim and center member, known as a disc or spider. The rim supports the tire and the spider (disc) connects the vehicle with the rim.

Wheels are usually of two types, namely the drop center and the semi-drop center. Drop center wheels are used on all cars, buses and trucks, which use tubeless tires; semi-drop center wheels are multi piece wheels used on vehicles with tubed tires.

Conventionally, in a vehicle, a tire is mounted onto a wheel and inflated to recommended pressure. In tubeless wheels, valve stem is fitted to the rim to inflate the tire. A valve stem is a self-contained valve which opens to admit the air into the chamber and is automatically closed and kept sealed by the pressure in the chamber to prevent the air from escaping.

In wheels of utility vehicles, the valve hole lies in the bottom or in the flank of the groove of the rim. The valves of these wheels are such that the stem of the valve runs alongside the interior wall of the rim and extends to the outside of the vehicle, passing through the opening in the wheel disc.

One problem encountered with the above arrangement of the stem valve such that the maintenance of valve stems. Valve stems rotate with the wheel of the vehicle. They are positioned between the rim and the axle where the braking components are housed. Often when the vehicle runs, foreign particles, stones, pebbles, penetrate the cavities between the rim, hub and the braking components. These particles might accumulate between the rim and the disc brake and rotate along with the wheel motion and can accumulate and jam the cavity between the valve stem (moving) and the brake mounting (stationary). In worst case scenarios, the result of the jamming of the foreign bodies between the moving valve stem and the stationary brake mounting may result in breakage of the stem valve or damage the rim or the brake mounting parts. This in turn would result in accidents due to sudden break failure.

Attempts have been made in the prior art to address the above problem, such as providing the valve stem outside the spider. This may give more clearance between rim and brake drum. Also, if the space between the two parts is increased then situations of valve stem damage due to caliper-brake fouling friction would be eliminated.

In the prior art EP0701911, a hump is provided between rim shoulder and cylindrical transition of a rim in a wheel in order to avoid load strain on valve stem. However, the hump is made an obstacle during mounting and unmounting of a tire on the rim since an outer bead of the tire must pass over the hump in order to reach its position on an outer seat of the rim. Further the hump can cause unbalanced rotations to the wheel.

In another prior art, U.S. Pat. No. 6,450,226 disposes a ledger instead of the hump on the valve hole region of the rim. Yet another prior art DE 102009056628 provides an interconnecting ring is disposed directly at an inner edge of a rim shoulder of the rim.

Though the above prior art may overcome the difficulties of the hump design of valve positioning in the rim, the ledger design or intermediate ring design of valve positioning may increase the processing time, additional components and manufacturing cost of the wheel.

Therefore, there is a need in the art to have a valve assembly in the rim of the wheel which can lead to an increased space between the valve stem and the drum which in turn not only results in pave the way for accommodating the larger brake drum without any hindrance, but also overcome the problem associated with the prior arts.

### OBJECTS OF THE INVENTION

A main object of the invention is to provide a drop center wheel with larger clearance between valve and drum/caliper.

Another object of the invention is to provide an external valve in the drop center wheel.

Still another object of the invention is to provide a wheel comprising a rim, a disc, and a valve, wherein the valve is positioned at outer bead seat of the rim.

Yet another object of the invention is to provide a valve hole positioning at the outer bead seat and adjacent to the connecting region of rim and disc, wherein the valve is positioned at the valve hole.

Another object of the invention is to provide a valve positioning at the outer bead seat and adjacent to the connecting region of rim and disc.

Another object of the invention to provide a wheel having substantial space for accommodating the larger brake drum without any hindrance.

Another object of the invention is to eliminate the hump, ledger and/or intermediate ring in the rim.

The other objects and advantages of the present invention will be apparent from the following description when read in conjunction with the accompanying drawings which are incorporated for illustration of preferred embodiments of the present invention and are not intended to limit the scope thereof.

### SUMMARY OF THE INVENTION

In view of the foregoing, an embodiment herein provides a commercial vehicle wheel comprises of a rim, and a disc, wherein the rim includes an outer flange, an inner flange, a straight outer bead seat, an inner bead seat, a connecting region for connecting the rim and disc, a circumferential mounting groove connected between the connecting region and inner bead seat, wherein a valve hole is provided in the straight outer bead seat for positioning a valve, wherein the valve stem is externally projecting outside the disc, thereby results in pave the way for achieving larger clearance between the valve and drum/calliper. According to an embodiment, the valve hole is provided at the straight outer bead seat without having hump, ledger or intermediate ring. Accordingly, the valve hole region only would have lower depth than other region of outer bead seat, and rest region of outer bead seat is provided in straight line without having hump, ledger and/or intermediate ring.

According to an embodiment, the rim and disc are joined together to form said connecting region, characterized in that the valve hole is provided adjacent to the connecting region to accommodate the valve and the valve hole is provided with out any hump, ledger or intermediate ring in the remaining region of outer bead seat. Further, the valve is positioned in the valve hole securely at predetermined angle.

According to an embodiment, the valve hole is provided at a predetermined angle to keep the valve in a straight line. In another embodiment, the valve hole is provided at predetermined angle to keep the valve at an inclined angle towards upper side for easy access by the user.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The detailed description is set forth with reference to the accompanying figures.

In the figures, the left-most digit(s) of a reference number identifies the figure in which the reference number first appears.

FIG. 1 illustrates an axial section of a wheel, wherein a valve is positioned at outer bead seat of the wheel according to an embodiment of the present invention;

FIG. 2 illustrates an axial section of a wheel, wherein a valve is positioned at outer beat seat of the wheel according to another embodiment of the present invention;

FIG. 3 illustrates an axial section of a wheel, wherein a valve hole provided at outer beat seat of the wheel according to an embodiment of the present invention;

FIG. 4 illustrates an axial section of a wheel, wherein a valve along with the valve hole provided at outer beat seat of the wheel according to an embodiment of the present invention; and

FIG. 5 illustrates three dimensional view of a wheel, wherein a valve hole provided at outer beat seat of the wheel according to an embodiment of the present invention.

### DETAILED DESCRIPTION OF THE PREFERRED EMBODIMENTS

The embodiments herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

As mentioned earlier, there is a need to develop a wheel having substantial clearance between valve and brake drum/calliper without any hindrance and also overcoming problem associated with the prior art. The embodiments herein achieve this by providing a valve passing through a valve hole, wherein the valve hole is positioned in the region of straight outer bead seat of a wheel, particularly adjacent to the joining portion of rim and disc.

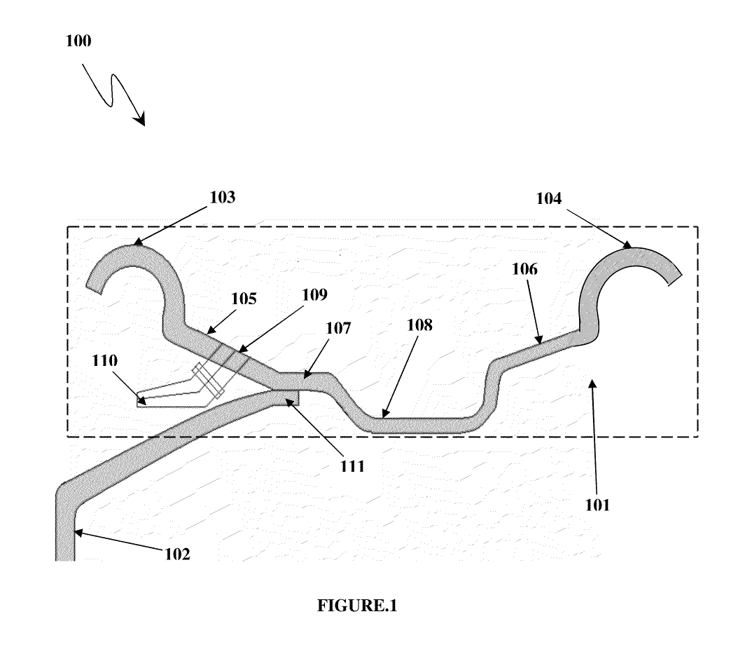

Now referring to FIG. 1, an axial section of a wheel 100 is illustrated in accordance with an embodiment of the present invention. The commercial vehicle wheel 100 comprises of a rim 101, a disc 102, wherein the rim 101 includes an outer flange 103, an inner flange 104, a straight outer bead seat 105, an inner bead seat 106, a connecting region 107 for connecting the rim 101 and disc 102, a circumferential mounting groove 108 connected between the connecting region 107 and inner bead seat 106. According to an embodiment, a valve hole 109 is provided in the straight outer bead seat 105 for positioning a valve 110 without having hump, ledger or intermediate ring in the outer bead seat 105, wherein the valve 110 stem is externally projecting outside the disc 102. Further, the valve hole 109 is directly provided adjacent to the connecting region 107 to accommodate the valve 110.

According to an embodiment, the outer bead seat 105 and inner beat seat 106 are provided to install/fix the tire on the rim of wheel. In an embodiment, the tire can be a tubeless type tire or tube type tire based on the requirement. The distance between the outer bead seat 105 and inner beat seat 106 are kept constant or variable according to conventional method. The angle of straight outer bead seat 105 can be kept at predetermined range, according to an embodiment.

According to an embodiment, the rim 101 and the disc 102 are connected through a connecting part 111 at the connecting region 107 with the help of any known welding process. The welding process is performed suitably to withstand the strength at the connecting part 111.

According to an embodiment, the circumferential mounting groove 111 is connected to the connecting region 107, with sufficient contact between the rim region 101 and disc region 102. The fatigue performance of the wheel is significantly influenced by the length of the contact between the two parts.

In an embodiment, the valve hole 109 is positioned at the straight outer bead seat 105 and externally projected outside the disc 102. In an embodiment, the diameter of the valve hole 109 can be kept constant, for example 9.7 mm. In another embodiment, the diameter of the valve hole 109 can be varied from a predetermined limit [9.0 mm-21 mm] to accommodate various size of valve 110. The valve hole size can be varied based on the valve stem to accommodate the variation in the inflation/deflation rate. Therefore, the valve hole 109 can be configured to accommodate the valve 110 in a desired diameter.

In an embodiment, the diameter of valve 110 stem can be varied based on the diameter of the valve hole 109. Further, the angle of valve 110 positioning with the valve hole 109 can be configured to keep the valve externally and projected outwards from the disc 102. Furthermore, the valve 110 stem can be straight line or can be provided at an inclined angle towards upper side for easy access by the user.

According to an embodiment, the valve hole 109 is positioned closely adjacent to the connecting region 107 and straight outer bead seat 105. Further, the valve 111 is positioned in the straight outer bead seat 105 without the need of hump, ledger and/or intermediate ring in the rim 101.

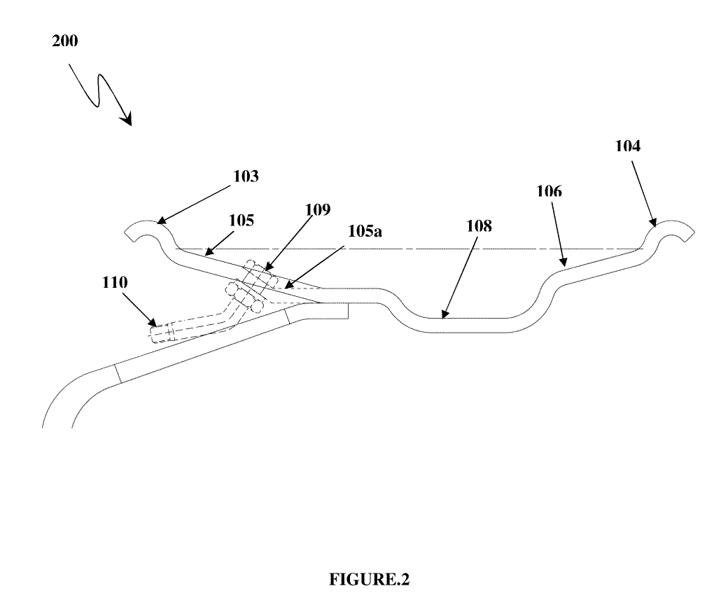

Now referring to FIG. 2, an axial section of a wheel 200 is illustrated in accordance with another embodiment of the present invention. Accordingly, the valve 111 is positioned in the outer bead seat 105 at an inclined angle, wherein the outer bead 105a profile is varied only at the valve position region as shown dotted in FIG. 2. At the valve position region 105a profile is made deeper than other region of outer bead seat 103. Further, valve position region 105a can be created using at least a method including flattening the region by press forming method. The valve 110 is positioned at the valve hole 109, wherein the valve hole 109 has a profile which may be deeper than the other region of outer bead seat 105.

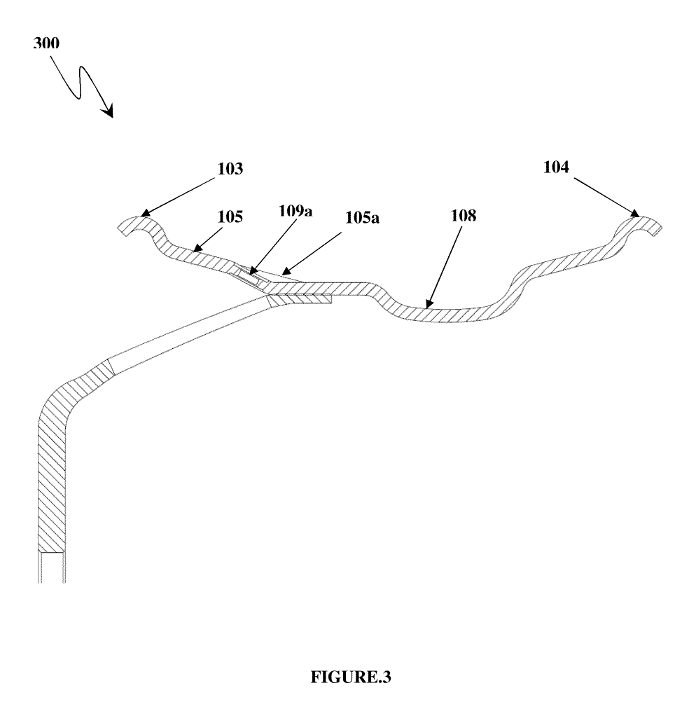

FIG. 3 illustrates an axial section 300 of a wheel, wherein a valve hole provided at outer beat seat of the wheel according to an embodiment. Before preparing the valve hole 109 is straight inline with the adjacent region 105a. At the time of making valve hole, the valve hole region is made with a profile 109a by using piercing or drilling the hole to a required diameter. After making the desired 109a profile and desired diameter of hole at the valve hole region, the valve can be placed at the valve hole region. In an embodiment, the diameter of the valve hole 109 can be kept constant. In another embodiment, the diameter of the valve hole 109 can be varied from a predetermined limit to accommodate various size of valve 110.

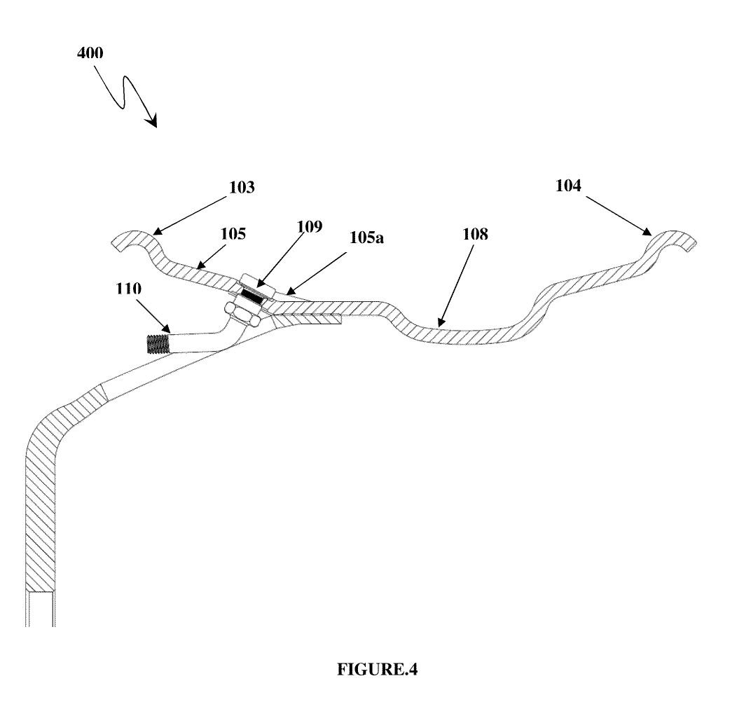

FIG. 4 illustrates an axial section 400 of a wheel, wherein a valve 110 along with the valve hole 109 provided at outer beat seat 105 of the wheel according to an embodiment. Accordingly, the valve hole 109 region only has a profile, wherein the profile can be created using a press forming method, Accordingly, the outer bead seat 105 is straight across the radius of rim 101, except the valve hole 109 region, wherein the valve 111 is positioned in the straight outer bead seat 105 without the need of hump, ledger or intermediate ring in the rim 101.

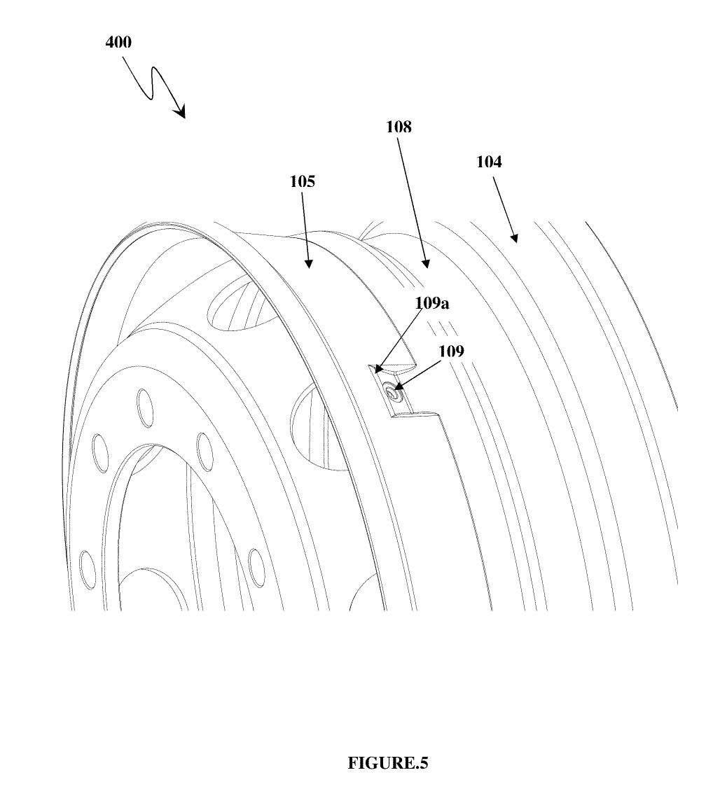

FIG. 5 illustrates three dimensional view 500 of a wheel, wherein a valve hole 109 provided at outer beat seat 105 of the wheel according to an embodiment. Accordingly, the valve 109 is provided by creating a profile 109a at one position of the outer bead seat 105, wherein the profile 109a can be created using a piecing or drilling method.

The main advantage of the present invention is that it solves a problem of valve getting damaged by the drum/caliper crown fouling.

Another advantage of the present invention is that it provides a wheel having substantial clearance between valve and brake drum/calliper without any hindrance.

Yet another advantage of the present invention to provide the external valve projected outside the disc and without the need of hump, ledger and/or intermediate ring in the rim, therefore the manufacturing process becomes simpler and thus can reduce the wheel manufacturing cost.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A commercial vehicle wheel comprising of
a rim 101, and a disc 102, wherein the rim 101 includes an outer flange 103, an inner flange 104, a straight outer bead seat 105, an inner bead seat 106, a connecting region 107 for connecting the rim 101 and disc 102, a circumferential mounting groove 108 connected between the connecting region 107 and inner bead seat 106, wherein a valve hole 109 is provided in the straight outer bead seat 105 for positioning a valve 110, wherein said valve 110 stem is externally projecting outside the disc 102.

2. The commercial vehicle wheel of claim 1, wherein said rim 101 and said disc 102 are joined together to form said connecting region 107, characterized in that the said valve hole 109 is provided adjacent to the connecting region 107 to accommodate said valve 110.

3. The commercial vehicle wheel of claim 1, wherein said valve 110 is positioned in said valve hole 109 securely at predetermined angle.

4. The commercial vehicle wheel of claim 1, wherein said valve hole 109 is provided at a predetermined angle to keep said valve 110 in a straight line.

5. The commercial vehicle wheel of claim 1, wherein said valve hole 109 is provided at a predetermined angle to keep said valve 110 at an inclined angle towards upper side for easy access by the user.

6. The commercial vehicle wheel of claim 1, wherein said valve 111 is positioned at an inclined angle at outer bead seat 105a.

7. The commercial vehicle wheel of claim 1, wherein said valve hole 109 ha a profile 109a, wherein the profile is created using a press forming method.

8. The commercial vehicle wheel of claim 8, wherein said outer bead seat is straight across the radius of rim except the valve hole 109 region.

9. The commercial vehicle wheel of claim 8, wherein said outer bead seat is provided without having hump, ledger and/or intermediate ring in the rim 101.

10. A commercial vehicle wheel substantially as herein described and as illustrated with the help of accompanying figures.
